(19) United States
(12) Patent Application Publication
(10) Pub. No.: US 2026/0316303 A1
(43) Pub. Date: Oct. 15, 2026

(54) DRIVE MECHANISM

(71) Applicant: Sony Interactive Entertainment Inc., Tokyo (JP)

(72) Inventors: Katsutsugu Fukamachi, Kanagawa (JP); Hiroshi Osawa, Kanagawa (JP)

(73) Assignee: Sony Interactive Entertainment Inc., Tokyo (JP)

(21) Appl. No.: 19/684,456

(22) Filed: May 21, 2026

Related U.S. Application Data
(63) Continuation of application No. PCT/JP2024/041002, filed on Nov. 19, 2024.

(30) Foreign Application Priority Data
Nov. 30, 2023 (JP) 2023-203282

(51) Int. Cl. B25J 17/02; B25J 9/10

(52) U.S. Cl. CPC B25J 17/0258; B25J 9/1065

(57) ABSTRACT

A drive mechanism includes first and second link mechanisms for tilting an operation target with a first axis as a first rotation center and a second axis, intersecting the first axis, as a second rotation center, respectively. First link mechanism includes a joint section coupled with the second link mechanism and the operation target is tiltable with the first or second rotation center. First and second link mechanisms each includes a holding section and a held section. A first biasing member biases the holding section of one of the first and second link mechanisms against the held section of the other of the first and second link mechanisms. The held section may include a ball joint, and the first biasing member biases the ball joint of the one of the first and second link mechanisms against the holding section of the other of the first and second link mechanisms.

### CROSS-REFERENCES TO RELATED APPLICATIONS

This application is a continuation of International Patent Application No. PCT/JP 2024/041002, filed on Nov. 19, 2024, which claims priority to Japanese Patent Application No. 2023-203282, filed on Nov. 30, 2023, the entire disclosure of which is incorporated herein by reference for all purposes.

### TECHNICAL FIELD

The present disclosure relates to a drive mechanism.

### BACKGROUND OF ART

PTL 1 discloses what is generally called a four-bar parallel link mechanism for moving a robot. In addition, a conventionally known mechanism has two four-bar parallel link mechanisms disposed in such a manner as to be perpendicular to each other, enabling movement in two axial directions. By using such a mechanism, it is possible to change the posture of an operation target by rotation in two axial directions.

### CITATION LIST

### Patent Literature

PTL 1

Japanese Patent Laid-open No. H 06-320449

### SUMMARY

### Technical Field

In the link mechanism that changes the posture of the operation target by rotation in two axial directions as described above, it is necessary to provide a joint section that can avoid interference between links caused by rotation in two axial directions. However, in such a link mechanism using the joint section, since the degree of freedom of movement is high, rattling tends to occur, and the operation target cannot accurately be operated in some cases.

An object of the present disclosure is to provide a drive mechanism that can accurately operate an operation target by suppressing rattling.

### Solution To Problem

According to the present disclosure, provided is a drive mechanism including a first link mechanism for tilting an operation target with a first axis as a rotation center and a second link mechanism for tilting the operation target with a second axis intersecting the first axis as a rotation center. The first link mechanism includes a first joint section that couples two links to each other and allows the operation target to be tilted with each of the first axis and the second axis as a rotation center and a first biasing member that biases one of a holding section included in one of the two links and a held section included in the other link and held by the holding section against the other.

### BRIEF DESCRIPTION OF THE DRAWINGS

FIG. 1 is a perspective view of a drive mechanism according to the present embodiment as viewed from the rear upper right.

FIG. 2 is a perspective view of the drive mechanism according to the present embodiment as viewed from the front upper left.

FIG. 3 is a top view of the drive mechanism according to the present embodiment as viewed from above.

FIG. 4 is a perspective view of the drive mechanism according to the present embodiment as viewed from above.

FIG. 5 is a right side view of the drive mechanism according to the present embodiment as viewed from the right.

FIG. 6 is a perspective view of the drive mechanism according to the present embodiment as viewed from below.

FIG. 7A is a schematic view for explaining an operation of a link when an eyeball member is tilted in a yaw direction and a pitch direction.

FIG. 7B is a schematic view for explaining an operation of the link when the eyeball member is tilted in the yaw direction and the pitch direction.

FIG. 7C is a schematic view for explaining an operation of the link when the eyeball member is tilted in the yaw direction and the pitch direction.

FIG. 8 is a schematic view for explaining a mechanism for suppressing rattling in the drive mechanism.

### DESCRIPTION OF EMBODIMENTS

### Outline

Hereinafter, an example of an embodiment of a drive mechanism according to the present disclosure will be described with reference to the drawings.

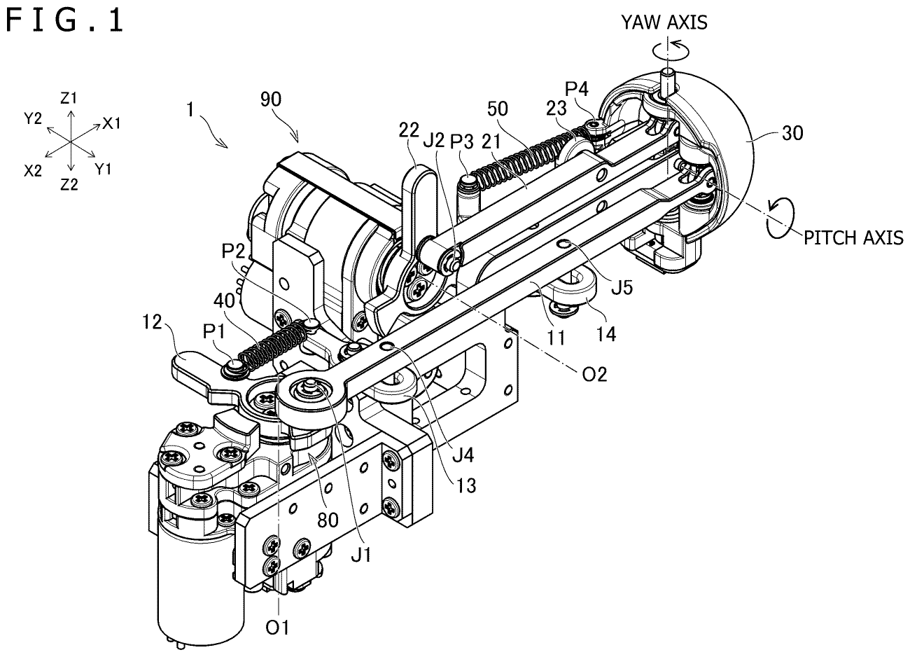

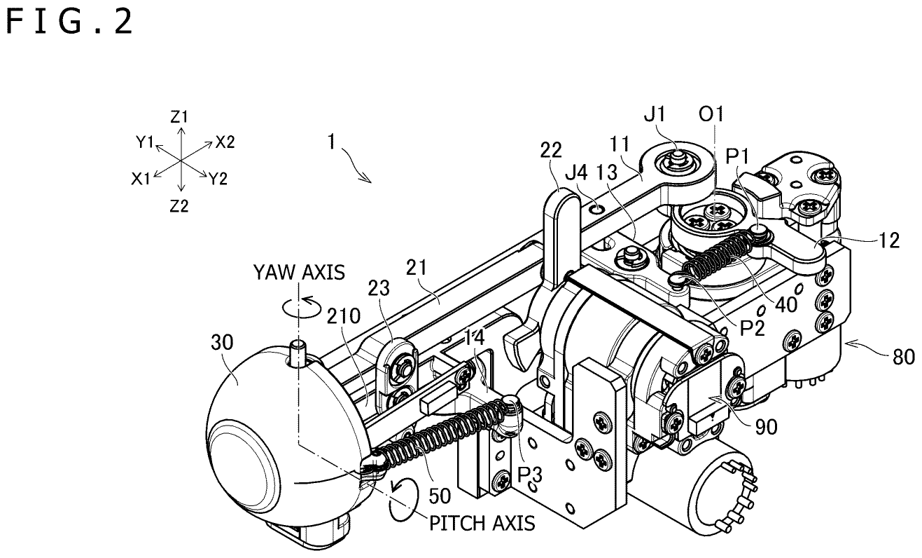

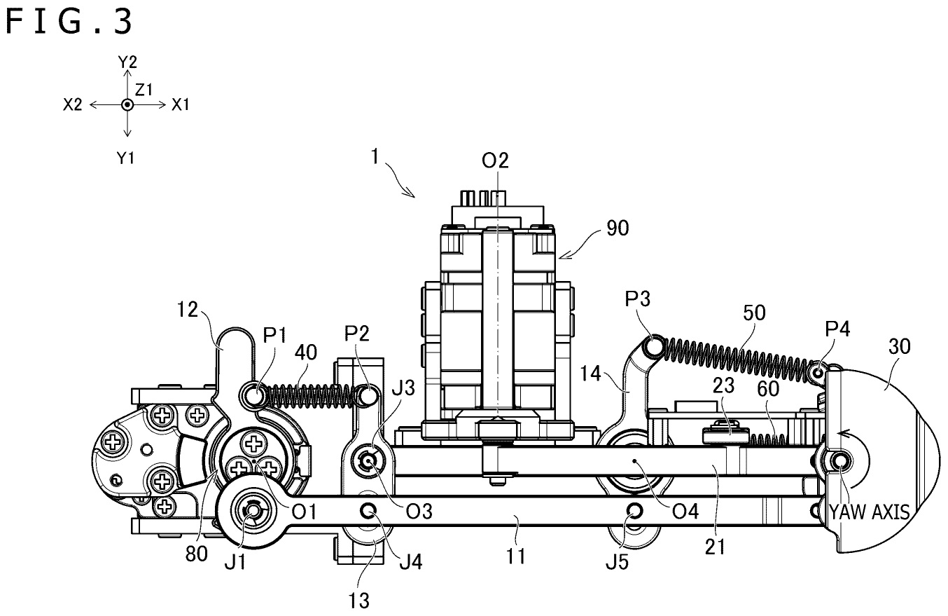

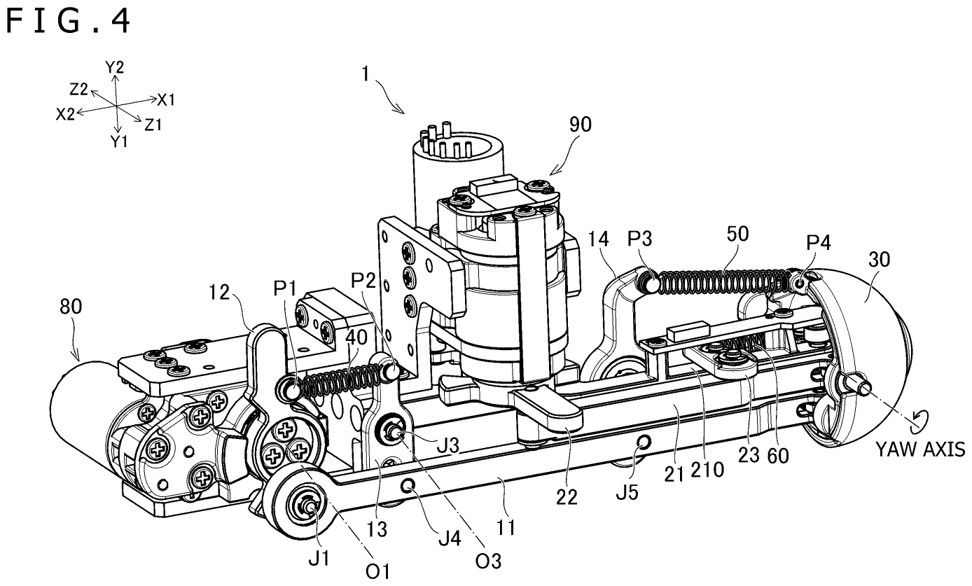

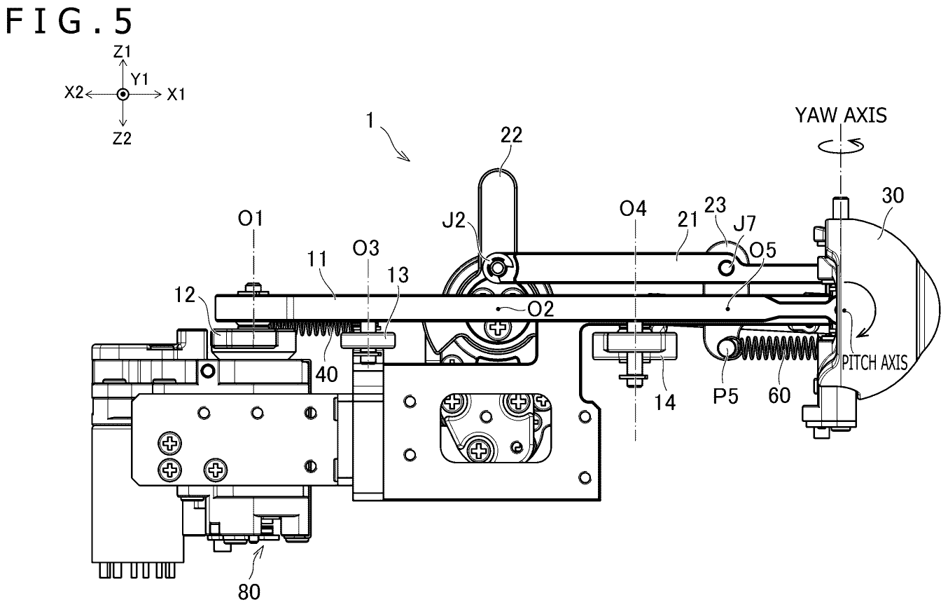

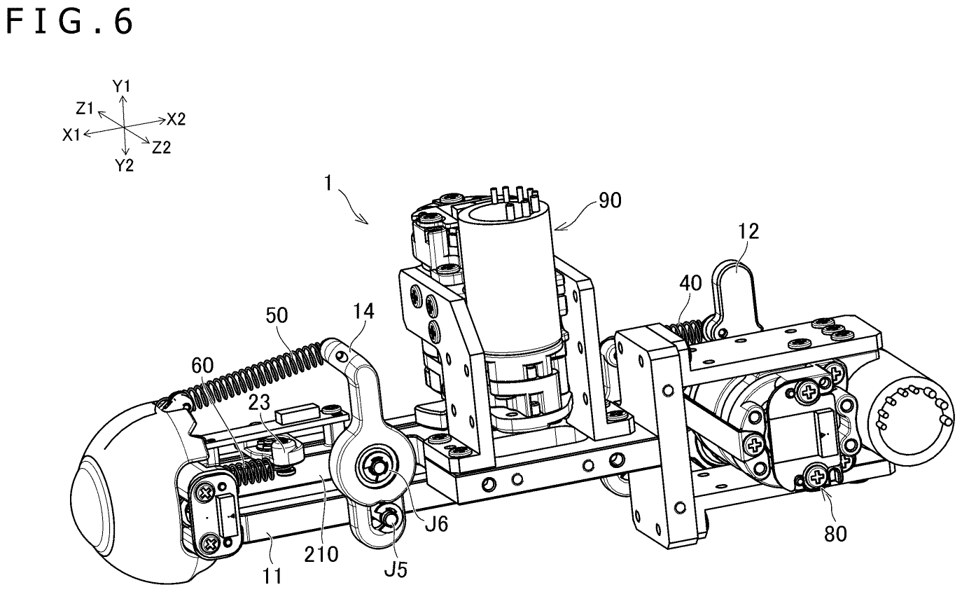

FIG. 1 is a perspective view of a drive mechanism according to the present embodiment as viewed from the rear upper right. FIG. 2 is a perspective view of the drive mechanism according to the present embodiment as viewed from the front upper left. FIG. 3 is a top view of the drive mechanism according to the present embodiment as viewed from above. FIG. 4 is a perspective view of the drive mechanism according to the present embodiment as viewed from above. FIG. 5 is a right side view of the drive mechanism according to the present embodiment as viewed from the right. FIG. 6 is a perspective view of the drive mechanism according to the present embodiment as viewed from below.

A vertical direction, a longitudinal direction, and a lateral direction in the present embodiment indicate directions based on a direction of a line of sight of an eyeball member 30 that is an operation target. The eyeball member 30 is a member having an appearance imitating a part of a human eyeball. In the present embodiment, the posture of the eyeball member 30 facing forward (an X1 direction in the drawing) will be referred to as a “basic posture.”

A drive mechanism 1 is a mechanism for tilting the eyeball member 30 from the basic posture to a yaw direction and a pitch direction. The yaw direction is a direction of rotation around a yaw axis in the drawing. The yaw axis is an axis extending in the vertical direction (a Z1 direction and a Z2 direction in the drawing). The pitch direction is a direction of rotation around a pitch axis in the drawing. The pitch axis is an axis extending in the lateral direction (a Y1 direction and a Y2 direction in the drawing). It should be noted that the yaw axis and the pitch axis mentioned here do not refer to physical members but axis lines serving as rotation centers. The eyeball member 30 is axially supported by the drive mechanism 1 in such a manner as to be rotatable around the yaw axis and the pitch axis.

The drive mechanism 1 includes a first link mechanism, a second link mechanism, the eyeball member 30, an actuator 80 that is a first power source, and an actuator 90 that is a second power source. The first link mechanism and the second link mechanism are each a mechanism which includes a plurality of links (also referred to as arms) and in which the links are rotatably coupled to each other through joint sections (also referred to as pairs).

### First Link Mechanism

The first link mechanism will be described mainly with reference to FIG. 3 and FIG. 4. The first link mechanism is a mechanism for tilting the eyeball member 30 in the yaw direction by being operated by power from the actuator 80.

The first link mechanism includes a first operation link 11 and a first drive link 12.

The first drive link 12 is driven by power from the actuator 80. Specifically, the first drive link 12 is rotated by power from the actuator 80 with an axis line O1 extending in the vertical direction as the rotation center. For example, the axis line O1 preferably coincides with the rotation center of the actuator 80. It should be noted that the rotation center of the first drive link 12 is immovable.

The first operation link 11 is a member extending in the longitudinal direction and operates the movement of the eyeball member 30 in the yaw direction. A front portion of the first operation link 11 is coupled to a right portion of the eyeball member 30, and a rear portion of the first operation link 11 is coupled to a right portion of the first drive link 12 through a joint section J1 described later. It should be noted that the front portion of the first operation link 11 is preferably coupled to the eyeball member 30 in such a manner as to allow the rotation in the yaw direction and the pitch direction.

The first operation link 11 is movable in the longitudinal direction by following the rotation of the first drive link 12. For example, in a case where the first drive link 12 is rotated counterclockwise in FIG. 3 with the axis line O1 as the rotation center, the first operation link 11 is moved forward according to the forward movement of the joint section J1. Accordingly, the eyeball member 30 is pushed forward by the first operation link 11, and the posture of the eyeball member 30 is tilted such that the line of sight thereof is directed to the left with the yaw axis as the center.

### Second Link Mechanism

The second link mechanism will be described mainly with reference to FIG. 1, FIG. 3, and FIG. 5. The second link mechanism is a mechanism for tilting the eyeball member 30 in the pitch direction by being operated by power from the actuator 90.

The second link mechanism includes a second operation link 21 and a second drive link 22.

The second drive link 22 is driven by power from the actuator 90. Specifically, the second drive link 22 is rotated by power from the actuator 90 with an axis line O2 extending in the lateral direction as the rotation center. For example, the axis line O2 preferably coincides with the rotation center of the actuator 90. It should be noted that the rotation center of the second drive link 22 is immovable.

The second operation link 21 is a member extending in the longitudinal direction and operates the movement of the eyeball member 30 in the pitch direction. A front portion of the second operation link 21 is coupled to an upper portion of the eyeball member 30, and a rear portion of the second operation link 21 is coupled to an upper portion of the second drive link 22 through a joint section J2. It should be noted that the front portion of the second operation link 21 is preferably coupled to the eyeball member 30 in such a manner as to allow the rotation in the yaw direction and the pitch direction.

The second operation link 21 is movable in the longitudinal direction by following the rotation of the second drive link 22. For example, in a case where the second drive link 22 is rotated clockwise in FIG. 5 with the axis line O2 as the rotation center, the second operation link 21 is moved forward according to the forward movement of the joint section J2. Accordingly, the eyeball member 30 is pushed forward by the second operation link 21, and the posture of the eyeball member 30 is tilted such that the line of sight thereof is directed downward with the pitch axis as the center.

### Ball Joint

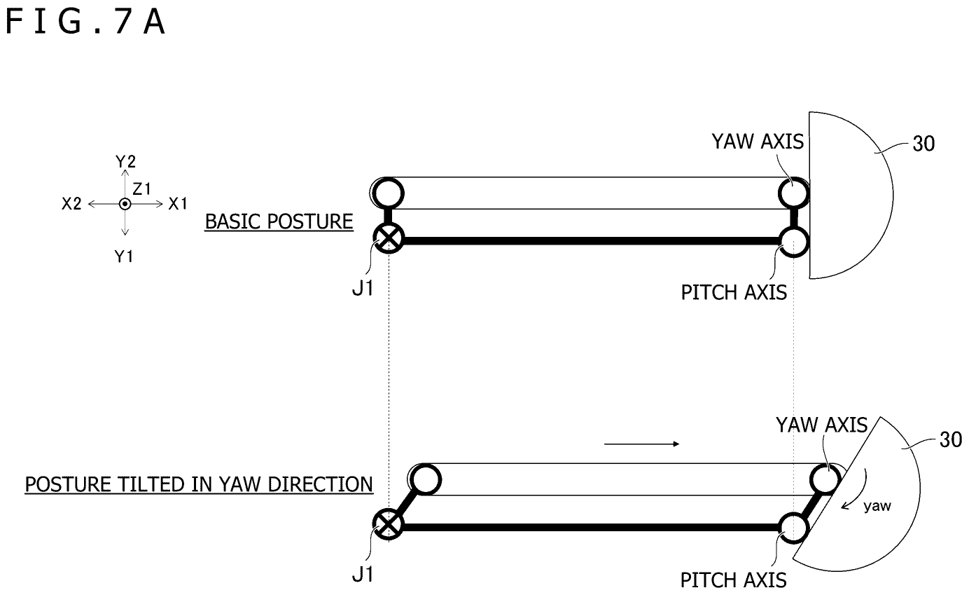

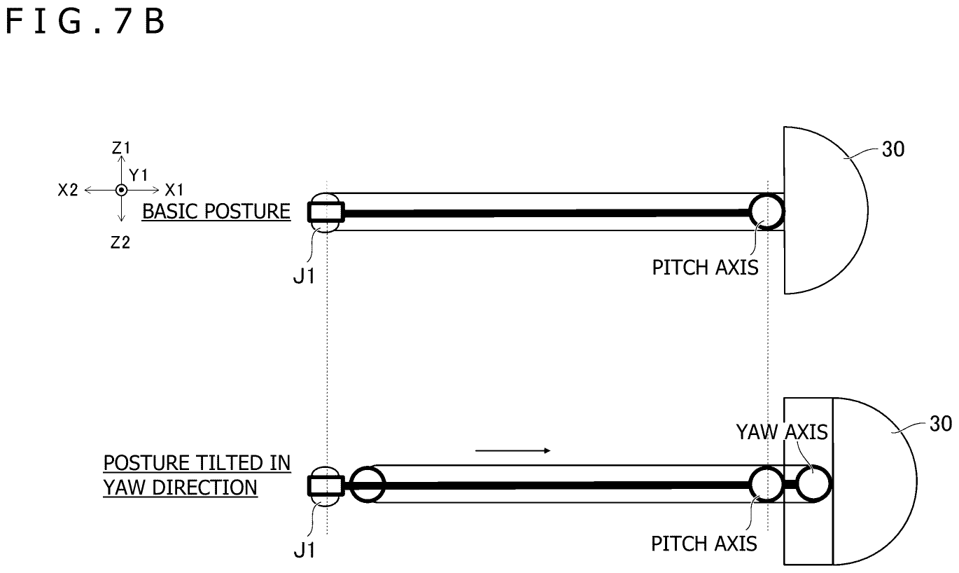

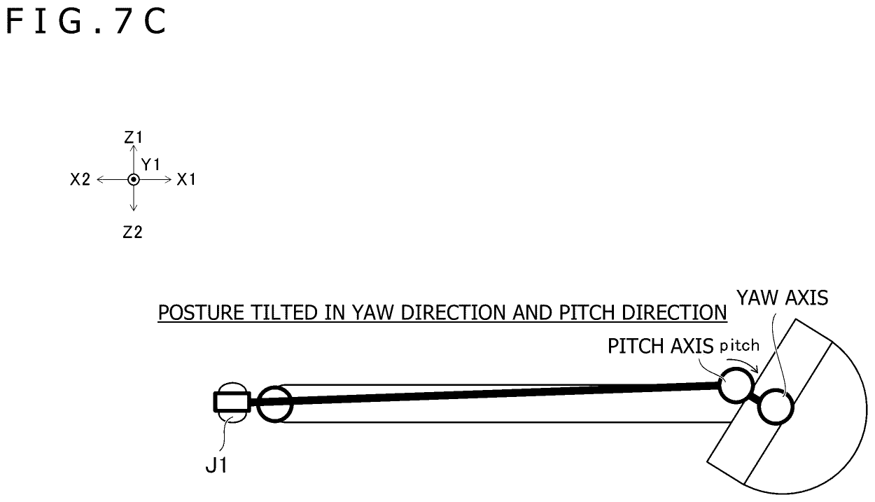

Here, the reason for using a ball joint in the link mechanism for tilting the eyeball member 30 in the yaw direction and the pitch direction will be described mainly with reference to FIG. 7A to FIG. 7C. The ball joint is a spherical portion that configures the joint section for coupling the links to each other and is rotatably held.

FIG. 7A to FIG. 7C are schematic views for explaining operations of the links when the eyeball member is tilted in the yaw direction and the pitch direction. It should be noted that FIG. 7A to FIG. 7C are only simplified schematic views for explaining the reason for using the ball joint in the mechanism for tilting the eyeball member 30 in the yaw direction and the pitch direction, and the specific mechanism is different from that of the present embodiment depicted in FIG. 1 to FIG. 6.

FIG. 7A depicts a state in which the eyeball member in the basic posture is viewed from above and a state in which the eyeball member with the posture tilted in the yaw direction is viewed from above. FIG. 7B depicts a state in which the eyeball member in the basic posture is viewed from the right and a state in which the eyeball member with the posture tilted in the yaw direction is viewed from the right. FIG. 7C depicts a state in which the eyeball member with the posture tilted in the yaw direction and the pitch direction is viewed from the right.

As depicted in FIG. 7A, in order to make the eyeball member 30 rotatable in the yaw direction, at least a part of each joint section of the link mechanism needs to be rotatable in the yaw direction. In addition, as depicted in FIG. 7B, in order to make the eyeball member 30 rotatable in the pitch direction, at least a part of each joint section of the link mechanism needs to be rotatable in the pitch direction. Therefore, in order to make the eyeball member 30 rotatable in two directions, i.e., the yaw direction and the pitch direction, as depicted in FIG. 7C, it is necessary to include the joint section J1 for allowing the rotation in the two directions, i.e., the yaw direction and the pitch direction.

Thus, in the drive mechanism 1 of the present embodiment, a configuration in which the first operation link 11 and the first drive link 12 are coupled to each other through the joint section J1 including the ball joint is adopted. Specifically, the ball joint is preferably provided at the right portion of the first drive link 12, and a holding section for holding the ball joint is preferably provided at the rear portion of the first operation link 11. With this configuration, the eyeball member 30 can be tilted in the two directions, i.e., the yaw direction and the pitch direction, while interference between the links is avoided.

### Suppression Of Rattling: First Additional Link And First Elastic Spring

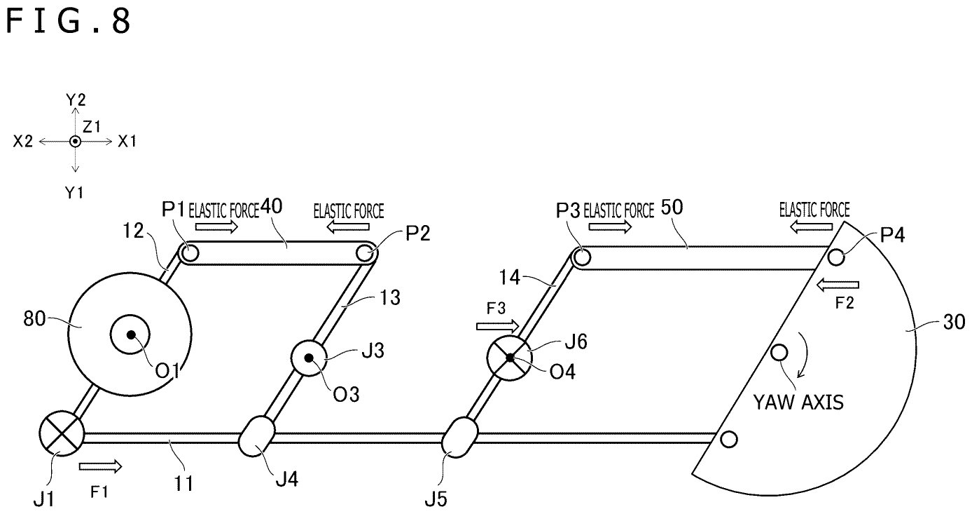

Next, a mechanism for suppressing rattling in the drive mechanism 1 will be described mainly with reference to FIG. 3 and FIG. 8. FIG. 8 is a schematic view for explaining a mechanism for suppressing rattling in the drive mechanism. It should be noted that FIG. 8 is a schematic view corresponding to the top view depicted in FIG. 3, and depicts a state in which the eyeball member 30 is tilted in the yaw direction.

As described above, the present embodiment adopts a configuration in which the first operation link 11 and the first drive link 12 are coupled to each other through the joint section J1 including the ball joint. In the configuration in which the ball joint is adopted, rattling may occur due to a gap between the ball joint and the holding section for holding the ball joint. Particularly, in a small-sized mechanism, a resin-made ball joint may be used from the viewpoint of ease of molding. The resin-made ball joint is likely to cause rattling as compared with a metal-made ball joint with high rigidity.

Thus, in the present embodiment, a configuration for suppressing rattling in the joint section J1 including a resin-made ball joint is adopted. Specifically, in the first link mechanism, a configuration including a first additional link 13 and a first elastic spring 40 as a first biasing member is adopted in addition to the configuration described above.

The first additional link 13 is rotatably supported with an axis line O3 extending in the vertical direction as the rotation center. It is preferable that the first additional link 13 be rotatably supported by a support base included in the drive mechanism 1 through a joint section J3. The joint section J3 preferably includes, for example, a round hole formed at the first additional link and a support shaft inserted into the round hole and formed at a fixed base.

A lower portion of the first additional link 13 is rotatably supported with respect to the first operation link 11 through a joint section J4. The joint section J4 is disposed between the joint section J1 and the eyeball member 30. For example, the joint section J4 preferably includes an elongated hole formed at a right portion of the first additional link 13 and a support shaft inserted into the elongated hole and formed at the first operation link 11.

The first elastic spring 40 is connected to a left portion of the first drive link 12 and a left portion of the first additional link 13. For example, it is preferable that the first elastic spring 40 be connected to the first drive link 12 by hooking a rear portion thereof on a protrusion P1 provided at the left portion of the first drive link 12. In addition, for example, it is preferable that the first elastic spring 40 be connected to the first additional link 13 by hooking a front portion thereof on a protrusion P2 provided at the left portion of the first additional link 13.

The first elastic spring 40 elastically biases the left portion of the first additional link 13 rearward by the elastic force thereof. Therefore, the first additional link 13 is biased in a counterclockwise direction in FIG. 8 with the axis line O3 as the rotation center. Thus, the lower portion of the first additional link 13 is biased forward. As a result, the joint section J1 including the ball joint is biased forward by a biasing force F1. Therefore, the occurrence of rattling caused due to a gap between the ball joint and the holding section for holding the ball joint is suppressed in the joint section J1.

The first operation link 11, the first elastic spring 40, the first drive link 12, and the first additional link 13 constitute what is generally called a four-bar parallel link. Therefore, the length between the protrusion P1 and the protrusion P2 is the same as the length between the joint section J1 and the joint section J4, and is unchanged. That is, the first elastic spring 40 is provided in such a manner as to maintain the same length, and always generates a constant elastic force. Therefore, the first elastic spring 40 applies the constant biasing force F1 to the joint section J1 including the ball joint regardless of the posture of the eyeball member 30, that is, regardless of the rotation angle of the actuator 80.

### Suppression Of Rattling: Second Additional Link And Second Elastic Spring

Further, as depicted in FIG. 3, FIG. 8, and other drawings, in the first link mechanism, a configuration including a second additional link 14 and a second elastic spring 50 as a second biasing member is adopted in addition to the configuration described above.

The second additional link 14 is rotatably supported with respect to a fixed link 210 with an axis line O4 extending in the vertical direction as the rotation center. The fixed link 210 is an immovable link extending in the longitudinal direction. The second additional link 14 and the fixed link 210 are coupled to each other through a joint section J6 including a ball joint. Specifically, the ball joint is preferably provided in the fixed link 210, and a holding section for holding the ball joint is preferably provided in the second additional link 14.

A right portion of the second additional link 14 is rotatably supported with respect to the first operation link 11 through a joint section J5. For example, the joint section J5 preferably includes an elongated hole formed at the right portion of the second additional link 14 and a support shaft inserted into the elongated hole and formed at the first operation link 11.

The second elastic spring 50 is connected to a left portion of the eyeball member 30 and a left portion of the second additional link 14. For example, it is preferable that the second elastic spring 50 be connected to the second additional link 14 by hooking a rear portion thereof on a protrusion P3 provided at the left portion of the second additional link 14. In addition, it is preferable that the second elastic spring 50 be connected to the eyeball member 30 by mounting a front portion thereof to a mounting section P4 provided at the left portion of the eyeball member 30.

As depicted in FIG. 8, the second elastic spring 50 elastically biases the left portion of the eyeball member 30 rearward by the elastic force thereof. Thus, the eyeball member 30 is biased rearward by a biasing force F2. Therefore, the rattling of the eyeball member 30 around the yaw axis is suppressed.

In addition, the second elastic spring 50 elastically biases the left portion of the second additional link 14 forward by the elastic force thereof. Thus, the joint section J6 is biased forward by a biasing force F3. Therefore, the occurrence of rattling caused due to a gap between the ball joint and the holding section for holding the ball joint is suppressed in the joint section J6.

The first operation link 11, the second elastic spring 50, the second additional link 14, and the eyeball member 30 constitute what is generally called a four-bar parallel link. Therefore, the length between the protrusion P3 and the mounting section P4 is unchanged. That is, the second elastic spring 50 is provided in such a manner as to maintain the same length, and always generates a constant elastic force. Therefore, the second elastic spring 50 applies the constant biasing force F2 to the eyeball member 30 and the constant biasing force F3 to the joint section J6 including the ball joint regardless of the posture of the eyeball member 30, that is, regardless of the rotation angle of the actuator 80.

### Suppression Of Rattling: Third Additional Link And Third Elastic Spring

Further, as depicted in FIG. 5 and other drawings, in the second link mechanism, a configuration including a third additional link 23 and a third elastic spring 60 as a third biasing member is adopted in addition to the configuration described above.

The third additional link 23 is rotatably supported with respect to the fixed link 210 (see FIG. 6; the fixed link 210 is disposed behind the first operation link 11 in FIG. 5) with an axis line O5 extending in the lateral direction as the rotation center. In addition, an upper portion of the third additional link 23 is rotatably supported with respect to the second operation link 21 through a joint section J7. For example, the joint section J7 preferably includes an elongated hole formed at the upper portion of the third additional link 23 and a support shaft inserted into the elongated hole and formed at the second operation link 21.

The third elastic spring 60 is connected to a lower portion of the eyeball member 30 and a lower portion of the third additional link 23. For example, it is preferable that the third elastic spring 60 be connected to the third additional link 23 by hooking a rear portion thereof on a protrusion P5 provided at the lower portion of the third additional link 23. In addition, it is preferable that the third elastic spring 60 be connected to the eyeball member 30 by mounting a front portion thereof to a mounting section (not illustrated) provided at the lower portion of the eyeball member 30.

The third elastic spring 60 biases the lower portion of the eyeball member 30 rearward by the elastic force thereof. Thus, the rattling of the eyeball member 30 around the pitch axis is suppressed. In addition, by using the third spring 60 and the second elastic spring 50 for suppressing the rattling of the eyeball member 30 around the yaw axis, the rattling of the eyeball member 30 can be suppressed in any direction around the yaw axis and the pitch axis.

### SUMMARY

In the drive mechanism 1 according to the present embodiment described above, the accuracy of the angle control of each link can be improved by suppressing the rattling. As a result, the eyeball member 30 as an operation target can be operated with high accuracy. Particularly, when the power from the power source is increased, the rattling tends to occur in the joint section, and the mechanism in the present embodiment effective in such a case.

In the present embodiment, the eyeball member 30 as an operation target has been described as an example, but the present invention is not limited to this. The operation target may relate to another part of a robot imitating a human or another animal. For example, the operation target may be a member imitating a human ankle or wrist, and the drive mechanism 1 may control the movement of the joint.

In addition, in the present embodiment, an example in which each of the link mechanisms has the joint section including the ball joint has been described, but the present invention is not limited to this, and a joint section having another configuration may be used as long as a structure for allowing the rotation in two axial directions is adopted. In addition, the material configuring the ball joint is not limited to resin.

In addition, in the present embodiment, an example in which the first link mechanism and the second link mechanism are disposed in such a manner as to be perpendicular to each other has been depicted, but the present invention is not limited to this, and it is sufficient if a configuration in which these mechanisms are disposed in such a manner as to intersect each other is adopted.

In addition, in the present embodiment, the elastic spring that is a coil spring as a biasing member has been described as an example, but the present invention is not limited to this, and other members and mechanisms may be adopted as long as the joint section and the eyeball member 30 are biased.

In addition, the yaw axis and the pitch axis depicted in the present embodiment are only examples, and the drive mechanism 1 may be a mechanism for controlling the movement in two axial directions with a roll axis as the rotation center.

### SUPPLEMENTARY NOTES

For example, the drive mechanism can be configured as follows.
(1)

A drive mechanism including:
a first link mechanism for tilting an operation target with a first axis as a rotation center; and
a second link mechanism for tilting the operation target with a second axis intersecting the first axis as a rotation center,
in which the first link mechanism includes
a first joint section that couples two links to each other and allows the operation target to be tilted with each of the first axis and the second axis as a rotation center, and
a first biasing member that biases one of a holding section included in one of the two links and a held section included in the other link and held by the holding section against the other.
(2)

The drive mechanism according to (1),
in which the held section is a ball joint, and
the first biasing member is provided in such a manner as to bias one of the ball joint and the holding section against the other.
(3)

The drive mechanism according to (1) or (2),
in which the first link mechanism includes
a first operation link that is coupled to the operation target and operates the operation target,
a first drive link that is coupled to the first operation link through the first joint section and is driven by power from a first power source, and
a first additional link that is coupled to the operation link between the first joint section and the operation target, and
the first biasing member is an elastic spring whose one end is connected to the first drive link and whose other end is connected to the first additional link.
(4)

The drive mechanism according to (3),
in which the first link mechanism includes
a second additional link that is coupled to the first operation link between the first additional link and the operation target, and
an elastic spring that is a second biasing member whose one end is connected to the second additional link and whose other end is connected to the operation target.
(5)

The drive mechanism according to (4),
in which the second link mechanism includes
a second operation link that is coupled to the operation target and operates the operation target,
a second drive link that is coupled to the second operation link and is driven by power from a second power source,
a third additional link that is coupled to the second operation link between the second drive link and the operation target, and
an elastic spring that is a third biasing member whose one end is connected to the third additional link and whose other end is connected to the operation target.
(6)

The drive mechanism according to (5),
in which the second biasing member is connected to the operation target in such a manner as to bias the operation target in one of a direction around the first axis and a direction around the second axis, and
the third biasing member is connected to the operation target in such a manner as to bias the operation target in the other of the direction around the first axis and the direction around the second axis.

What is claimed is:

1. A drive mechanism comprising:
a first link mechanism for tilting an operation target with a first axis as a first rotation center; and
a second link mechanism for tilting the operation target with a second axis as a second rotation center, the second axis intersecting the first axis,
wherein:
the first link mechanism comprises a joint section coupled with the second link mechanism to allow the operation target to be tilted with the first rotation center or the second rotation center,
each one of the first link mechanism and the second link mechanism comprises a holding section and a held section, and
a first biasing member biases the holding section of one of the first link mechanism and the second link mechanism against the held section of the other one of the first link mechanism and the second link mechanism.

2. The drive mechanism of claim 1, wherein:
the held section comprises a ball joint, and
the first biasing member biases the ball joint of the one of the first link mechanism and the second link mechanism against the holding section of the other one of the first link mechanism and the second link mechanism.

3. The drive mechanism of claim 1, wherein:
the first link mechanism comprises:
a first operation link coupled with the operation target for tilting the operation target,
a first drive link coupled with the first operation link through the joint section to be driven by power from a first power source, and
a first additional link coupled with the operation link between the joint section and the operation target; and
the first biasing member comprises an elastic spring with one end connected with the first drive link and an opposing end connected with the first additional link.

4. The drive mechanism of claim 3, wherein the first link mechanism comprises:
a second additional link coupled with the first operation link between the first additional link and the operation target; and
a second biasing member comprising second elastic spring with one end connected with the second additional link and an opposing end connected with the operation target.

5. The drive mechanism of claim 4, wherein the second link mechanism comprises:
a second operation link coupled with the operation target for tilting the operation target;
a second drive link coupled with the second operation link to be driven by power from a second power source;
a third additional link coupled with the second operation link between the second drive link and the operation target; and
a third biasing member comprising a second elastic spring with one end connected with the third additional link and an opposing end connected with the operation target.

6. The drive mechanism of claim 5, wherein:
the second biasing member is connected with the operation target to bias the operation target in a first direction around one of the first axis and the second axis, and
the third biasing member is connected with the operation target to bias the operation target in a second direction around one of the first axis and the second axis, the second direction being different from the first direction.
